(19) United States
(12) Patent Application Publication
(10) Pub. No.: US 2009/0254359 A1
(43) Pub. Date: Oct. 8, 2009

(54) SYNCHRONIZED INTERACTIVE DEMOGRAPHIC ANALYSIS

(76) Inventors: Ronald R. Bandy, Plano, TX (US); Donald R. Hancock, Frisco, TX (US); Lane J. Segerstrom, McKinney, TX (US); Phillip W. Williams, Plano, TX (US)

Correspondence Address: Deleon Law Group PC, Suite 700, 100 Crescent Court, Dallas, TX, 75201, US

(21) Appl. No.: 12/246,347

(22) Filed: Oct. 6, 2008

Related U.S. Application Data
(60) Provisional application No. 60/977,997, filed on Oct. 5, 2007.
(60) Provisional application No. 60/978,028, filed on Oct. 5, 2007.
(60) Provisional application No. 60/978,028, filed on Oct. 5, 2007.

(51) Int. Cl. G06Q 99/00

(52) U.S. Cl. 705/1

(57) ABSTRACT

An embodiment of the present invention includes a system and method of providing synchronized interactive demographic analysis.

### CROSS-REFERENCE TO RELATED APPLICATION

Applicants claim priority based on provisional patent applications Ser. Nos. 60/977,997; and 60/978,028, both filed Oct. 5, 2007, and concurrent filing non-provisional patent application based on 60/978,028, entitled: “Unique Identification System,” the entire contents of which are incorporated herein by reference.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example embodiment of the present invention;

FIG. 2 is a flow diagram of an embodiment of the present invention;

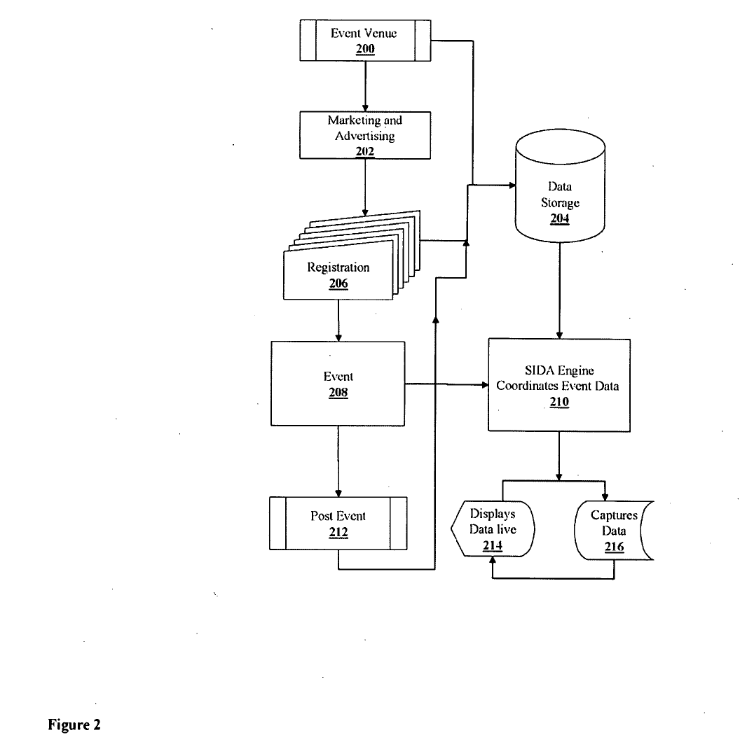

FIG. 3 is another example embodiment of the present invention;

FIG. 4 is yet another example embodiment of the present invention; and

FIG. 5 is yet another example embodiment of the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown but is to be accorded the widest scope consistent with the principles and features disclosed herein.

The present invention relates generally to a system and method of providing a synchronized interactive demographic analysis.

Political candidates often speak about their priorities and how they feel about different issues in a public forum. One method is to record their speech on a televised event, such as a debate. However, the candidates usually can not see a large audience's rating for different parts of the speech based on demographics.

Therefore, a need exists for a system and method of providing synchronized interactive demographic analysis.

An embodiment of the present invention includes a system and method of providing synchronized interactive demographic analysis.

One embodiment of the present invention includes an event called the “Virtual Political Rally” (VPR). This event will invite individual candidates to present their platforms in a non-threatening, non-combative environment. The object is to give the candidate more time than a two-minute debate response; as well as allowing the candidate to explain the logic and nuances behind his/her position. This event allows the Political Candidates themselves to find value in the responses of the audience to what they have said.

As each participating candidate gives his/her speech, the audience will rate their approval level using a slider bar on their computer (another method of rating uses a dial rather than a slider bar.) At the end of the event, the data along with the corresponding video will be instantly available by signing onto the appropriate website and activating the present invention online. Alternatively, a CD or “thumb drive” can be delivered to each candidate's team for on-going analysis. In either case, the media will include the statistical program as well as all the demographic data collected during their event. However, the data will have no individually recognizable information as a matter of privacy of our audience.

Another embodiment of the present invention includes its application in online product focus groups. Under this embodiment, participants will rate their approval level of a live or pre-recorded presentation of a new or enhanced product or service. As the presentation progresses, the Registrants will indicate their approval or disapproval of features, advantages, and benefits. The accumulated demographic information will be available during the presentation, as well as instantly available for review immediately following any session via sign-in.

Another embodiment of the present invention provides for individual Members to set up their own event or focus group without the intervention of the Inventors' management. Under this embodiment, any Member can post his/her own presentation and invite other Members or Resources to evaluate the product or concept interactively. The data will become instantaneously available to the Member Sponsor of the event.

Because of the nature of the data collected, it is not necessary for every use to be in a specific event simultaneously. Individual evaluations may take place on posted presentations at diverse times. As any Registrant completes his/her evaluation, the data is immediately added to the rest of the data completed by other Registrants at other times.

The Member Sponsor may even replace parts of a presentation in the middle of a campaign, and determine the change in demographic approval from one version to the next over time; in this manner improving the product concept before release.

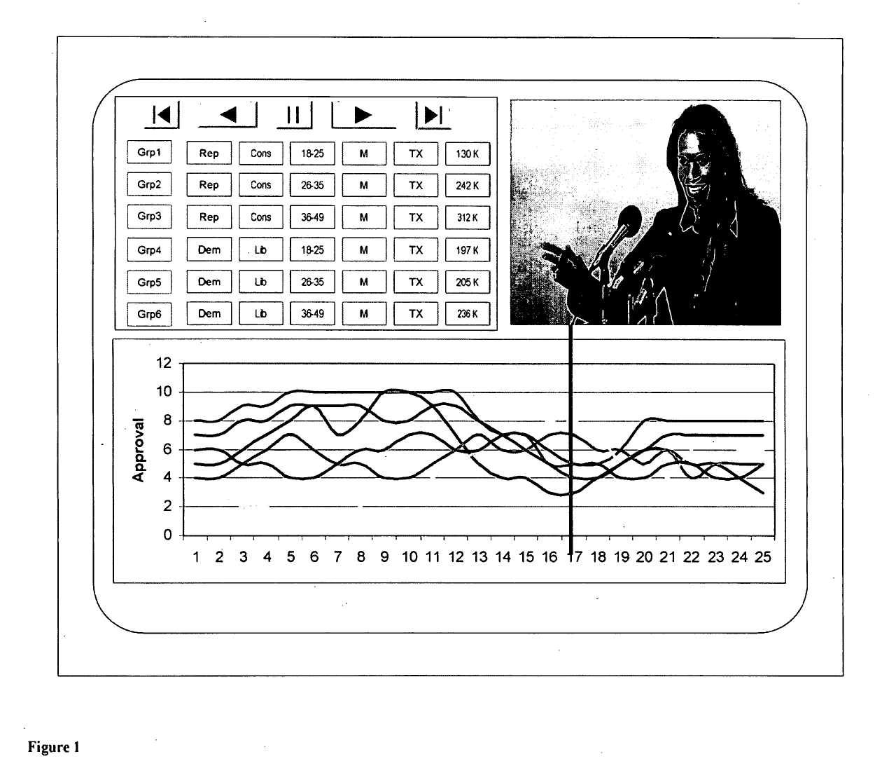

When the rating program is started, a display will appear which gives the Candidate's speech video on one corner, and six “Approval Lines” underneath. A control panel for controlling the video and the “Approval Line” options is always visible. (See FIG. 1).

The lines indicate the average “approval rating” of all viewers in the demographic selected. Each demographic characteristic for each line is a pull-down. As the candidate speaks, an analyst may pause the video, change the demographic selections and then rewind and replay using the new demographics. In addition, the analyst could change the demographic definition of a line in real time, and the system would, mid-speech, automatically start making the new calculations based on the new definition. The total number (the number closest to the speaker in FIG. 1) of viewers is the average of the demographic set selected.

The system provides the data directly to the buyer (normally, the candidate's organization) and allow them to do whatever analysis they choose. Other competitor solutions require significant computing power to get the data in useable form. The system produces personal computer useable data and the analysis program runs properly and responsively, provided an up-to-date computer is used. In addition, the interface to synthesize the data is simple and intuitive to operate. The candidates can do whatever they want with the information. The system does not analyze the data, nor make projections or suggestions for improving the candidate's reception. That is up to the candidate.

In addition, since the system is not affiliated with any political party, religious organization, or special interest group, it acts as a totally neutral supplier where others may not be neutral.

FIG. 1 illustrates how a typical event can occur. The designer, sponsor or coordinator first defines and setups an event and choose the venue 200. Marketing and advertising then occurs through US Mail, email or other methods 202. Each registrant then completes his own data in prepared e-form 206. The registrant's ID temporarily changes to reflect Event Interests. Then the information is then stored a database 204.

The event then occurs 208 while an engine coordinates 210 event data with live inputs from the registrants. The data is then displayed 214 live to Sponsors while saving the data 216 for later analysis.

After the event 212, the registrant's ID is returned to its original value. However, the temporary event values are kept in the database 204 for future verification and analysis.

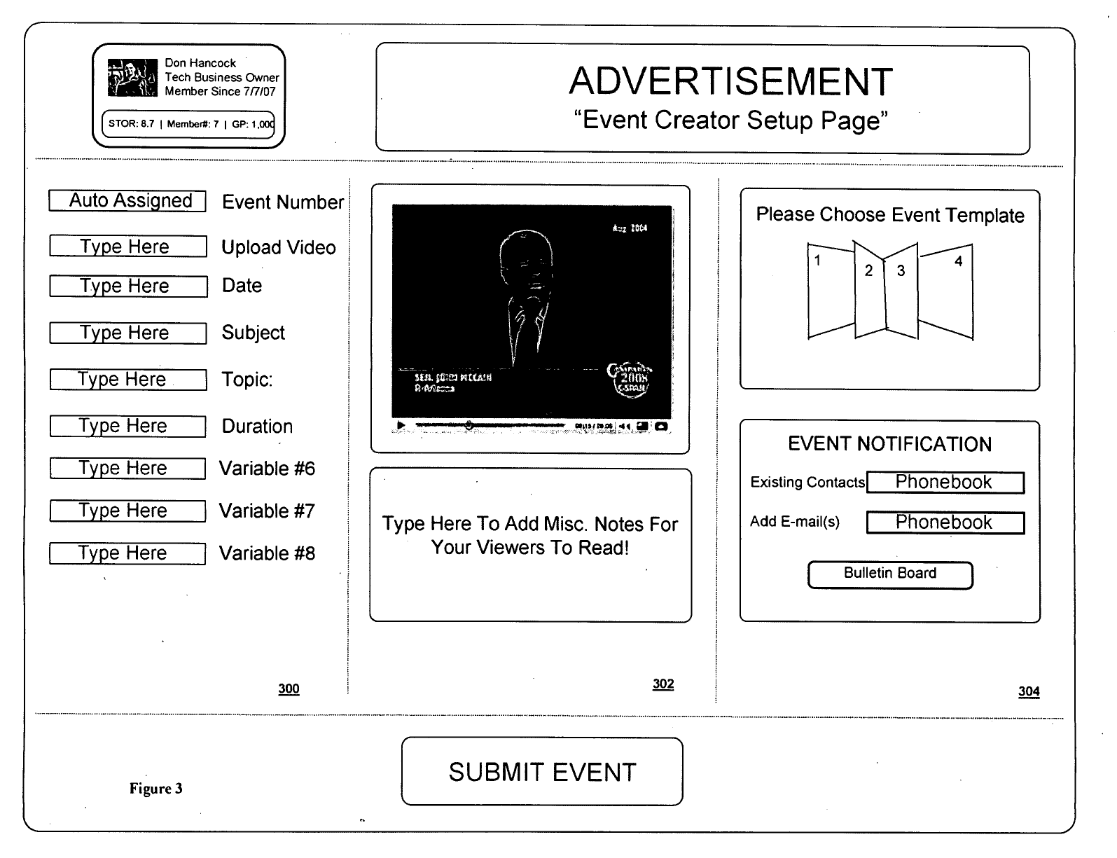

FIG. 3 is another example embodiment of the present invention. In this example, is to fill out the information on the left most portion 300 of the screen. The second step is to upload a video and type any miscellaneous notes for the viewers to read as shown in the center portion 302. The third step is to choose and event template and setup contacts as shown on the right most portion 304 of the screen.

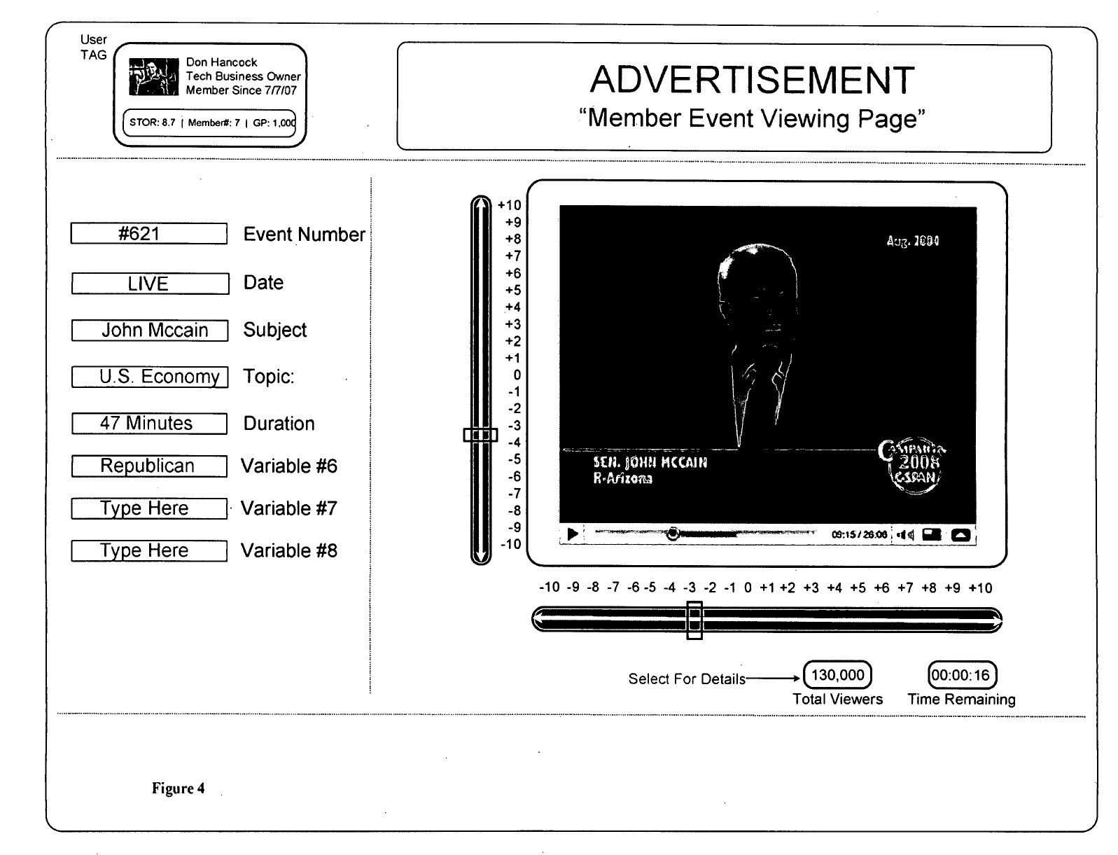

FIG. 4 is yet another example embodiment of the present invention. In this embodiment, users may be provided with various sliding, and/or dial, gauges. Optional position of gauge may be available to allow ease of use. Depending on the variables entered by “poster” the gauges will read from −10 to +10 according to user response. The range will equate, in simplest form, from bad to good. However the “poster” may also create detailed variables beyond good and bad to create a comprehensive analysis given their Event topic (i.e. Democrat/Republican). Also, in this embodiment, a participant may not use another member's ID—they must use their ID number.

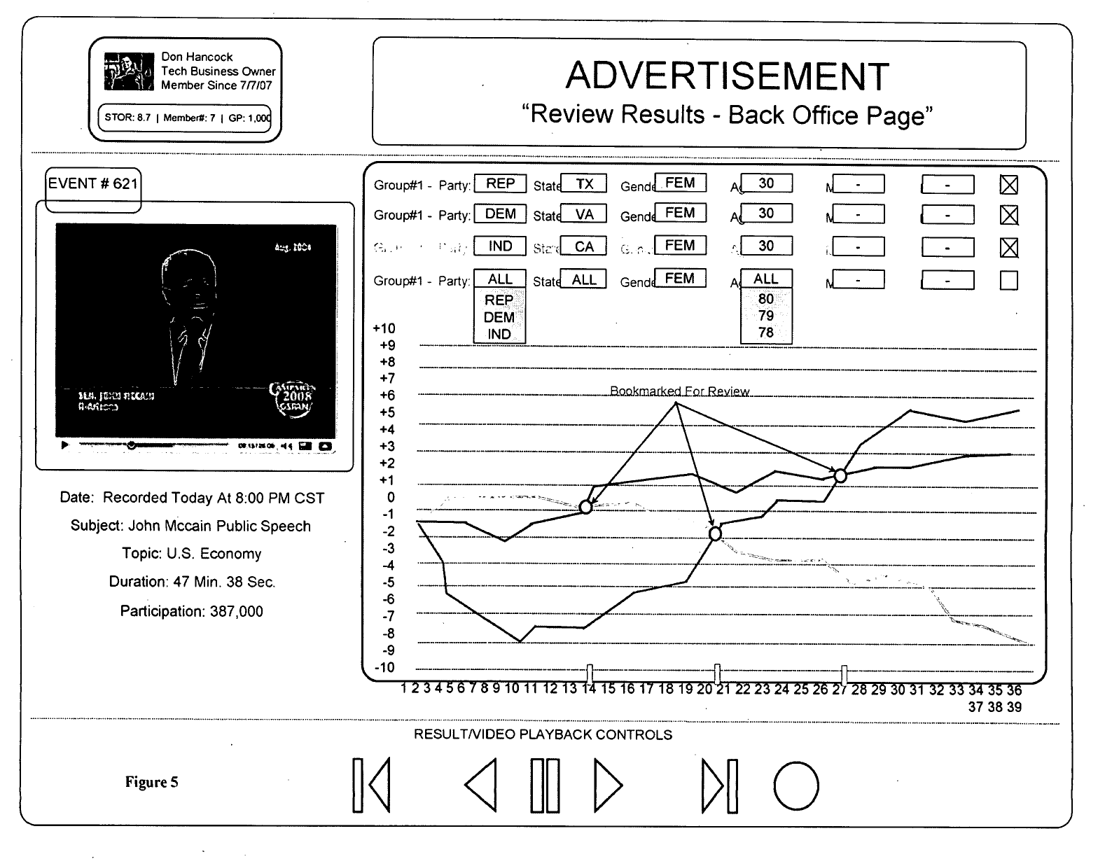

FIG. 5 is yet another example embodiment of the present invention. In this embodiment, space is provided on the sides of the control buttons that is available for advertisements.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of providing synchronized interactive demographic analysis, the method comprising:
creating an event;
registering members for viewing the event;
recording demographic information regarding the members viewing the event;
recording interests of the members viewing the event at periodic times during the event;
storing the interests and demographic information of members viewing the event; and
analyzing the interests and demographic information.
